(19) United States
(12) Patent Application Publication
(10) Pub. No.: US 2017/0290724 A1
(43) Pub. Date: Oct. 12, 2017

(54) Waste Collection System

(71) Applicants: Christopher Rojas, Coral Gables, FL (US); Marco Cabrera, Coral Gables, FL (US)

(72) Inventors: Christopher Rojas, Coral Gables, FL (US); Marco Cabrera, Coral Gables, FL (US)

(21) Appl. No.: 15/093,962

(22) Filed: Apr. 8, 2016

(51) Int. Cl. A61G 9/00; A47K 11/10

(52) U.S. Cl. CPC A61G 9/003; A47K 11/105

(57) ABSTRACT

A waste collection system for collecting feces includes a bedpan. A liner is removably positioned within the bedpan. The liner may capture feces deposited into the bedpan thereby facilitating the feces to be removed from the bedpan. The liner has a bag portion and a skirt portion. The skirt portion is removable from the bag portion.

### BACKGROUND OF THE DISCLOSURE

### Field of the Disclosure

The disclosure relates to collection devices and more particularly pertains to a new collection device for collecting feces.

### SUMMARY OF THE DISCLOSURE

An embodiment of the disclosure meets the needs presented above by generally comprising a bedpan. A liner is removably positioned within the bedpan. The liner may capture feces deposited into the bedpan thereby facilitating the feces to be removed from the bedpan. The liner has a bag portion and a skirt portion. The skirt portion is removable from the bag portion.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top perspective view of a waste collection system according to an embodiment of the disclosure.

FIG. 2 is a back view of an embodiment of the disclosure.

FIG. 3 is an exploded perspective view of an embodiment of the disclosure.

FIG. 4 is a perspective in-use view of an embodiment of the disclosure.

FIG. 5 is a cross sectional view taken along line 5-5 of FIG. 4 of an embodiment of the disclosure.

### DESCRIPTION OF THE PREFERRED EMBODIMENT

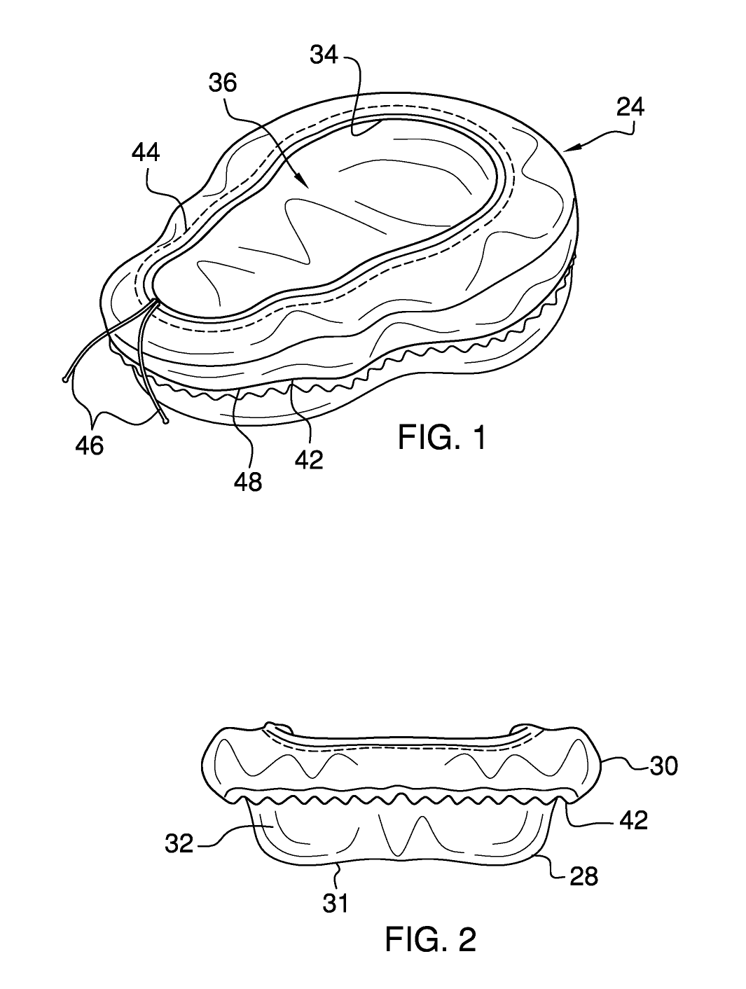

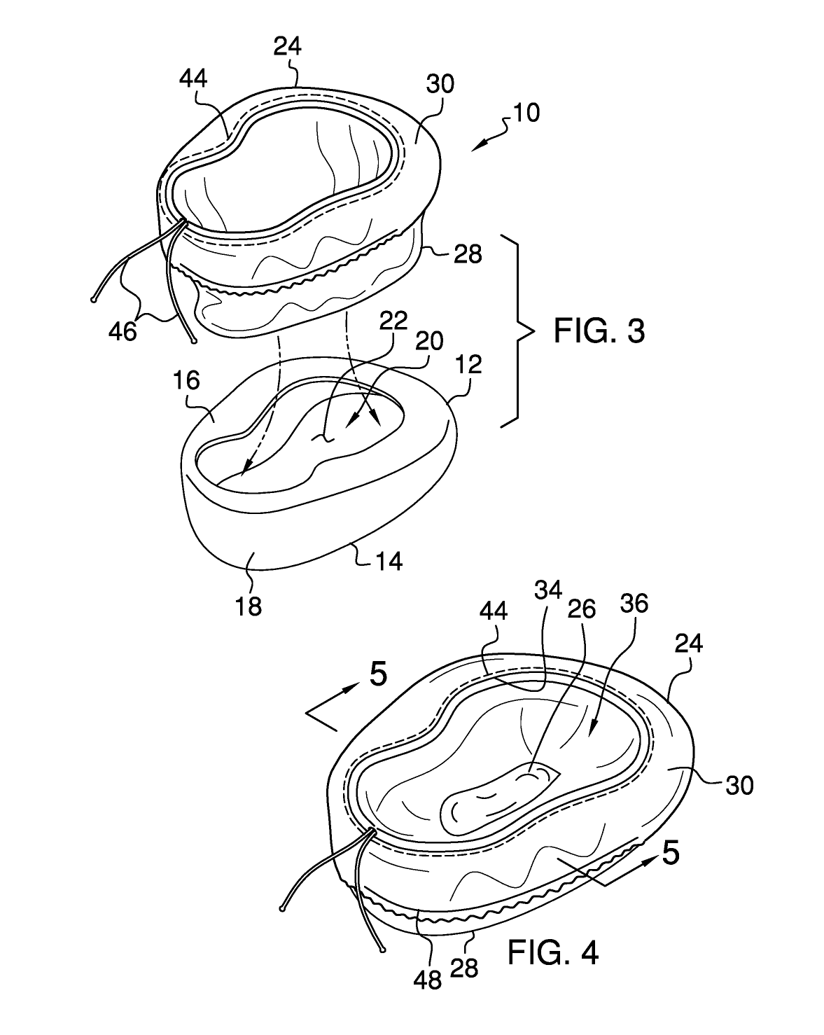

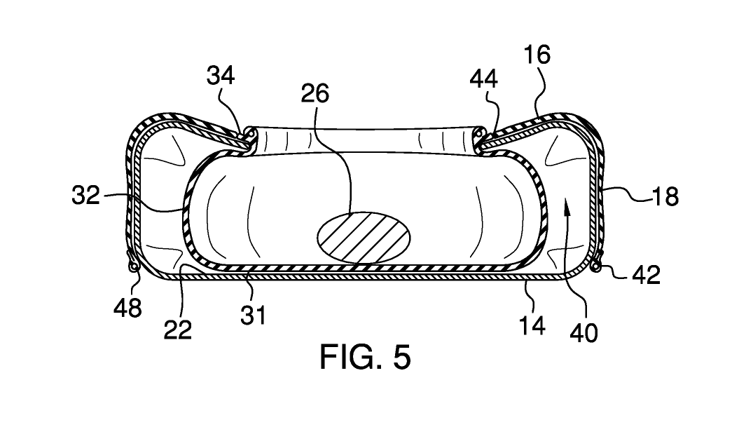

With reference now to the drawings, and in particular to FIGS. 1 through 5 thereof, a new collection device embodying the principles and concepts of an embodiment of the disclosure and generally designated by the reference numeral 10 will be described.

As best illustrated in FIGS. 1 through 5, the waste collection system 10 generally comprises a bedpan 12 that has a lower wall 14, an upper wall 16 and a peripheral wall 18 extending between the upper wall 16 and the lower wall 14. The upper wall 16 has an opening 20 extending therethrough and the lower wall 14 has an upper surface 22. A liner 24 is removably positioned within the bedpan 12. Thus, the liner 24 may capture feces 26 deposited into the bedpan 12 thereby facilitating the feces 26 to be removed from the bedpan 12. The liner 24 may be comprised of a deformable and fluid impermeable material such as plastic or the like.

The liner 24 has a bag portion 28 and a skirt portion 30. The bag portion 28 has a bottom wall 31 and a perimeter wall 32 extending upwardly from the bottom wall 31. The perimeter wall 32 has a distal edge 34 with respect to the bottom wall 31 and the distal edge 34 defines an opening 36 into the bag portion 28. The bottom wall 31 has a lower surface 38.

The skirt portion 30 extends downwardly along the perimeter wall 32 and the skirt portion 30 is coextensive with the distal edge 34. The skirt portion 30 is spaced from the perimeter wall 32 to define a space 40 between the skirt portion 30 and the perimeter wall 32. The skirt portion 30 has a distal edge 42 with respect to the perimeter wall 32. The skirt portion 30 has a perforation 44 that is coextensive with the distal edge 34 of the bag portion 28. Thus, the skirt portion 30 is removable from the bag portion 28.

A drawstring 46 is slidably coupled to the perimeter wall 32 such that the drawstring 46 may be manipulated. The drawstring 46 is coextensive with the distal edge 34 of the bag portion 28. Thus, the drawstring 46 selectively closes the bag portion 28 and the drawstring 46 selectively removes the skirt portion 30 from the bag portion 28.

An elastic member 48 is coupled to the skirt portion 30. The elastic member 48 is coextensive with the distal edge 42 of the skirt portion 30. The elastic member 48 frictionally engages the peripheral wall 18 when the liner 24 is positioned on the bedpan 12. Thus, the elastic member 48 removably retains the liner 24 on the bedpan 12.

In use, the bag portion 28 is positioned within the bedpan 12 having the lower surface 38 of the bag portion 28 abutting the upper surface 22 of the bedpan 12. The skirt portion 30 is extended over the upper wall 16 and downwardly along the peripheral wall 18 of the bedpan 12 such that the peripheral wall 18 is positioned within the space 40. The bedpan 12 is positioned to capture the feces 26. The drawstring 46 is manipulated when the feces 26 are deposited in the bag portion 28. The drawstring 46 tears the perforation 44 such that the skirt portion 30 is removed from the bag portion 28. The drawstring 46 simultaneously closes the bag portion 28 thereby facilitating the feces 26 to be contained within the closed bag portion 28. The closed bag portion 28 is removed from the bedpan 12 and the closed bag portion 28 is discarded.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A waste collection system comprising:
a bedpan; and
a liner being removably positioned within said bedpan wherein said liner is configured to capture feces deposited into said bedpan thereby facilitating the feces to be removed from said bedpan, said liner having a bag portion and a skirt portion, said skirt portion being removable from said bag portion.

2. The system according to claim 1, wherein said bedpan has a lower wall, an upper wall and a peripheral wall extending between said upper wall and said lower wall, said upper wall having an opening extending therethrough, said lower wall having an upper surface.

3. The system according to claim 1, wherein said bag portion had a bottom wall and a perimeter wall extending upwardly from said bottom wall, said perimeter wall having a distal edge with respect to said bottom wall, said distal edge defining an opening into said bag portion, said bottom wall having a lower surface.

4. The system according to claim 3, wherein said skirt portion extends downwardly along said perimeter wall, said skirt portion being coextensive with said distal edge, said skirt portion being spaced from said perimeter wall to define a space between said skirt portion and said perimeter wall, said skirt portion having a distal edge with respect to said perimeter wall, said skirt portion having a perforation being coextensive with said distal edge of said bag portion.

5. The system according to claim 4, wherein said bag portion is positioned within said bedpan having said lower surface abutting said upper surface, said skirt portion being extended over said upper wall and downwardly along said peripheral wall such that said peripheral wall is positioned within said space.

6. The system according to claim 3, further comprising a drawstring being slidably coupled to said perimeter wall wherein said drawstring is configured to be manipulated, said drawstring being coextensive with said distal edge of said bag portion such that said drawstring selectively closes said bag portion when said skirt portion is removed from said bag portion.

7. The system according to claim 4, further comprising an elastic member being coupled to said skirt portion, said elastic member being coextensive with said distal edge of said skirt portion, said elastic member frictionally engaging said peripheral wall when said liner is positioned on said bedpan, said elastic member removably retaining said liner on said bedpan.

8. A waste collection system comprising:
a bedpan having a lower wall, an upper wall and a peripheral wall extending between said upper wall and said lower wall, said upper wall having an opening extending therethrough, said lower wall having an upper surface;
a liner being removably positioned within said bedpan wherein said liner is configured to capture feces deposited into said bedpan thereby facilitating the feces to be removed from said bedpan, said liner having a bag portion and a skirt portion, said bag portion having a bottom wall and a perimeter wall extending upwardly from said bottom wall, said perimeter wall having a distal edge with respect to said bottom wall, said distal edge defining an opening into said bag portion, said bottom wall having a lower surface, said skirt portion extending downwardly along said perimeter wall, said skirt portion being coextensive with said distal edge, said skirt portion being spaced from said perimeter wall to define a space between said skirt portion and said perimeter wall, said skirt portion having a distal edge with respect to said perimeter wall, said skirt portion having a perforation being coextensive with said distal edge of said bag portion such that said skirt portion is removable from said bag portion, said bag portion being positioned within said bedpan having said lower surface abutting said upper surface, said skirt portion being extended over said upper wall and downwardly along said peripheral wall such that said peripheral wall is positioned within said space;
a drawstring being slidably coupled to said perimeter wall wherein said drawstring is configured to be manipulated, said drawstring being coextensive with said distal edge of said bag portion such that said drawstring selectively closes said bag portion when said skirt portion is removed from said bag portion; and
an elastic member being coupled to said skirt portion, said elastic member being coextensive with said distal edge of said skirt portion, said elastic member frictionally engaging said peripheral wall when said liner is positioned on said bedpan, said elastic member removably retaining said liner on said bedpan.
